(19) United States
(12) Patent Application Publication
(10) Pub. No.: US 2002/0144292 A1
(43) Pub. Date: Oct. 3, 2002

(54) Bi-directional CATV system, line equipment, center equipment

(76) Inventors: Jun Uemura, Nisshin-shi (JP); Masayuki Satake, Nisshin-shi (JP); Toshihiro Sugiura, Nisshin-shi (JP)

Correspondence Address: DAVIS & BUJOLD, P.L.L.C., 500 NORTH COMMERCIAL STREET, FOURTH FLOOR, MANCHESTER, NH, 03101, US

(21) Appl. No.: 10/078,015

(22) Filed: Feb. 15, 2002

(30) Foreign Application Priority Data
Feb. 19, 2001 (JP) 2001-41670

(51) Int. Cl. H04N 7/173; H04N 7/16

(52) U.S. Cl. 725/127; 725/124; 725/149

(57) ABSTRACT

When a noise level of upward signal received by a center equipment exceeds a predetermined maximum noise level, line equipment located the closest upstream from a noise source is specified and attenuation of the upward signal on the specified line equipment is increased in levels until the noise level of the upward signal received by the center equipment is equal to or under the maximum noise level. Accordingly, it is possible to prevent abnormal noise to affect the whole system without interrupting the upward signal from a cable modem located downstream of the noise source to the center equipment.

### BACKGROUND OF THE INVENTION

1. Technical Field of the Invention

This invention relates to a bi-directional CATV system, and line equipment and a center equipment used in the bi-directional CATV system, in which a plurality of line equipment are connected to transmission lines from the center equipment to subscriber side terminal devices.

2. Description of the Related Art

In a conventional bi-directional CATV system, line equipment (such as bi-directional amplifier, branching device, etc.) provided on transmission lines from a center equipment to subscriber side terminal devices (such as cable modem, set top box (STB), etc.) comprise a status monitor for monitoring a output signal level, power voltage level, etc.

The line equipment in the bi-directional CATV system also comprise a gate switch for opening and closing a passing path of upward signal. In order to control confluence noise relating to upward signal, this gate switch is operated by means of the status monitor's facility for communicating with the center equipment to cut off the transmission lines through which the upward signal is not transmitted.

Additionally, as disclosed in Unexamined Japanese Patent Publication No. 6-245212, for example, in order to avoid spreading a bad influence deriving from abnormal noise over the whole system in case that a noise level of the upward signal exceeds an allowable range, the gate switch of a bi-directional amplifier located upstream of the noise source is operated to cut off the noise source from the system.

When the gate switch is opened due to the excess of the noise level of the upward signal over the allowable range, cause of the noise is investigated and removed by an engineer sent to the site, and then the gate switch is closed for recovery.

Accordingly, once the gate switch is opened, the subscriber side terminal devices connected downstream of the noise source cannot receive services by means of upward signal, e.g. connecting to the Internet via the center equipment, for a comparatively long period till the above recovery operations are completed.

### SUMMARY OF THE INVENTION

One object of the present invention is to introduce a bi-directional CATV system in which, upon increase of a noise level of upward signal, the noise level of the upward signal received by a center equipment can be substantially reduced without interrupting a flow of the upward signal from a path where a noise source exists.

In order to attain the above object, a first aspect of this invention provides a bi-directional CATV system, in which when a noise level of upward signal received by a center equipment exceeds a predetermined maximum noise level, a noise source is searched to specify a line equipment located the closest upstream of the noise source, and attenuation of the upward signal at the line equipment (hereafter, referred to as “specified line equipment”) is increased.

According to the present invention, if the attenuation of the upward signal at the above specified line equipment is substantially increased until the noise level of the upward signal received by the center equipment falls within an allowable range, it is not only possible to prevent the noise deriving from the noise source from affecting the other equipment, but also improve reliability of communication by means of upward signal since the noise level of the upward signal in the whole system is always kept at or under a certain level.

Although a signal level of the upward signal sent from the subscriber side terminal devices (e.g. cable modem, set top box, etc.) located downstream of the above specified line equipment is attenuated together with the noise level at the specified line equipment, communication can be maintained despite decreased communication quality since there is normally a system margin.

If the center equipment, as in a second aspect of the present invention, is adapted to automatically adjust the signal level of the upward signal sent from the subscriber side terminal devices so that the signal level of the received upward signal falls within the predetermined allowable range, the noise generated at the noise source is decreased and thus only the signal level of the upward signal from the subscriber side terminal devices located downstream of the specified line equipment is increased. In other words, transmission quality (i.e. S/N ratio and C/N ratio) of the upward signal outputted by the specified line equipment is improved compared to that prior to the increase of the attenuation of the upward signal. Therefore, even in the downstream of the above specified line equipment, communication with the center equipment can be secured and services by means of upward signal are maintained without substantially lowering the transmission quality.

The line equipment herein represent CATV amplifiers and CATV bridger amplifiers which amplify, branch and merge upward signal and downward signal, branching devices called tap-offs, boosters provided in information distribution boards of the subscriber's houses, or any other equipment which can be connected to the transmission lines from the center equipment to the subscriber side terminal devices.

In the third aspect of the present invention, line equipment comprise a signal attenuating means for varying attenuation of upward signal to a center equipment according to attenuation adjustment signal superimposed on downward signal from the center equipment.

In the sixth aspect of the present invention, a center equipment comprises a noise level detection means for detecting noise in a frequency band used for transmission of upward signal, a search means for searching a noise source, in case that the noise level exceeds a predetermined maximum noise level, to specify a line equipment located the closest upstream of the noise source, and a noise adjustment means for generating attenuation adjustment signal for adjusting attenuation of the upward signal at the line equipment specified by the search means so that the noise level detected by the noise level detection means is kept at or under the maximum noise level, and then mixing this attenuation adjustment signal on downward signal to be transmitted.

Accordingly, with the line equipment of the third aspect and the center equipment of the sixth aspect of the present invention, it is possible to specify the line equipment located the closest upstream of the noise source when the noise level of the upward signal received by the center equipment exceeds the predetermined maximum noise level, to increase the attenuation of the upward signal at the line equipment. In short, the line equipment of the third aspect and the center equipment of the sixth aspect of the present invention can be advantageous for constituting the bi-directional CATV system of the first aspect of the present invention.

In the seventh aspect of the present invention, the center equipment comprises a signal level detection means for detecting a signal level of the received upward signal, and a level adjustment means for generating level adjustment signal for adjusting a transmission level of the upward signal at the subscriber side terminal devices so that the signal level falls within a predetermined allowable range, and then mixing the level adjustment signal on downward signal to be transmitted. In short, the center equipment of the seventh aspect of the present invention is advantageous for constituting the bi-directional CATV system of the second aspect of the present invention.

The line equipment may, as in the fourth aspect of the present invention, comprise a distribution means for distributing downward signal from the center equipment to plural destinations, and a switch means for controlling passing and blocking of the downward signal at every distribution path through which the signal distributed at the distribution means is transmitted according to switch signal superimposed on the downward signal from the center equipment.

If such a line equipment of the present invention is applied to a branching device, so-called tap-off, for branching signal on the transmission line into signal lines (branching paths) lead into each subscriber house, it is possible not to transmit downward signal from unused branching terminals, and thus unauthorized use of CATV services via the unused branching terminals can be discouraged. In addition, it is possible to block confluence noise coming from the unused branching terminals and thus prevent lowering of upward signal quality.

However, the switch means dealing with high-frequency signal flowing through the transmission lines of the CATV system cannot completely block passing of the signal when it is in the off state. Enhancing isolation of the switch means accompanies heavy expenditure.

Therefore, when the line equipment is provided with such a switch means as above, it is preferable that the line equipment also comprise a noise mixing means for working with the switch means and generating white noise to be superimposed downstream of the switch means when the switch means is set to block passing of downward signal, as in the fifth aspect of the present invention.

In this manner, when the switch means is in the off state, leaked signal passing the switch means is buried in the white noise and cannot be identified. Thus the above-mentioned unauthorized use is securely prevented.

### BRIEF DESCRIPTION OF THE DRAWINGS

The invention will now be described, by way of example, with reference to the accompanying drawings, in which:

FIG. 1 is a block diagram showing a constitution of a bi-directional CATV system according to an embodiment of the present invention;

FIGS. 2A and 2B are block diagrams showing a constitution of line equipment;

FIGS. 3A, 3B and 3C are explanatory views showing a constitution and operation of a gate switch;

FIG. 4 is a flow chart showing steps of a noise level adjustment program;

FIG. 5 is a flow chart showing steps of a noise source search program;

FIG. 6 is a flow chart showing steps of a noise level measurement program;

FIG. 7 is a flow chart showing steps of a maximum noise level update program;

FIGS. 8A and 8B are block diagrams showing an internal constitution of an information distribution board and a constitution of a booster according to the second embodiment;

FIGS. 9A and 9B are block diagrams showing a constitution of a gate part of a branching device according to the third embodiment, and a constitution of a gate switch provided on a downward path; and

FIGS. 10A and 10B are explanatory views showing signal passing characteristics at a branching terminal.

### DETAILED DESCRIPTION OF THE INVENTION

[First Embodiment]

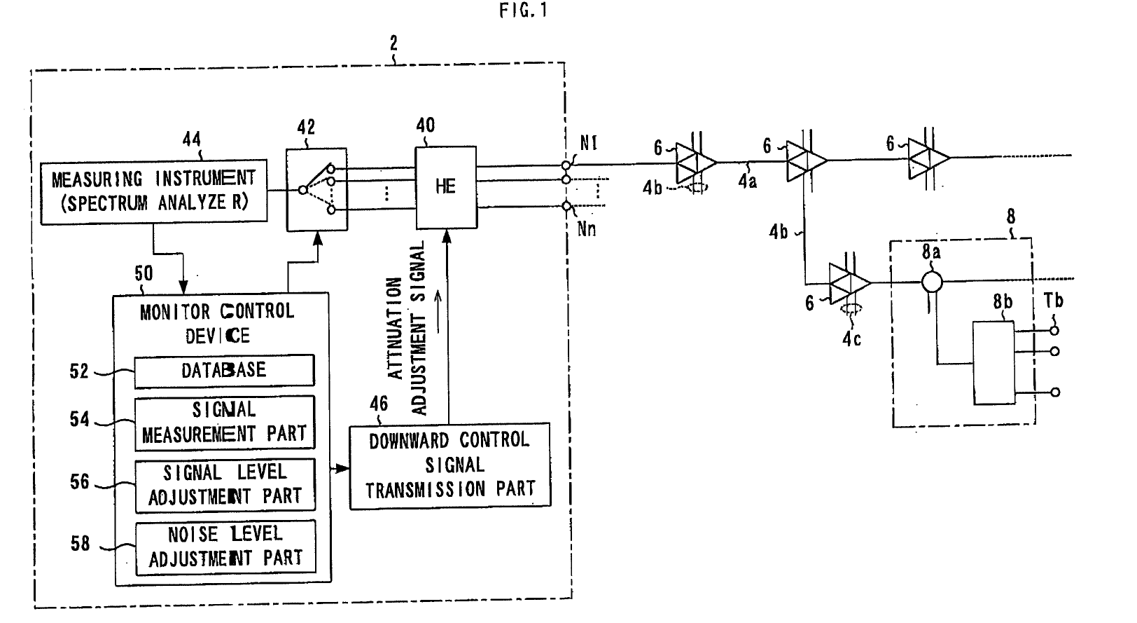

FIG. 1 is a schematic view of a CATV system according to an embodiment of the present invention. In the CATV system of the present embodiment, transmission signal having a predetermined transmission frequency band (for example, ranging from 54 MHz-860 MHz) is used for downward signal from a center equipment 2 to terminal sides, and transmission signal having a transmission frequency band (for example, ranging from 5 MHz-42 MHz) lower than the downward signal is used for upward signal from the terminal sides to the center equipment 2.

As shown in FIG. 1, the CATV system of the first embodiment comprises transmission lines 4 (4a, 4b and 4c) which extend from the center equipment 2 to terminals to which subscriber side terminal devices of the present system are connected. The transmission lines 4 are constituted from a trunk 4a, multiple branch lines 4b (hereinafter, referred to as “branches”) branching from the trunk 4a, sub-branch lines 4c further branching from each of the branches 4b and so on. The transmission lines 4 are connected to each other like a tree.

These transmission lines 4 are provided with a plurality of bi-directional amplifiers (i.e. CATV bridger amplifier, CATV amplifier) 6 and branching devices 8. The bi-directional amplifiers 6 amplify transmission signal flowing bi-directionally through the transmission lines 4 and if required, branch/merge the transmission signal. The branching devices 8 are so-called tap-offs which branch the transmission signal flowing through the transmission lines 4 to be lead into subscriber houses. These bi-directional amplifiers 6 and branching devices 8 correspond to the line equipment of the present invention.

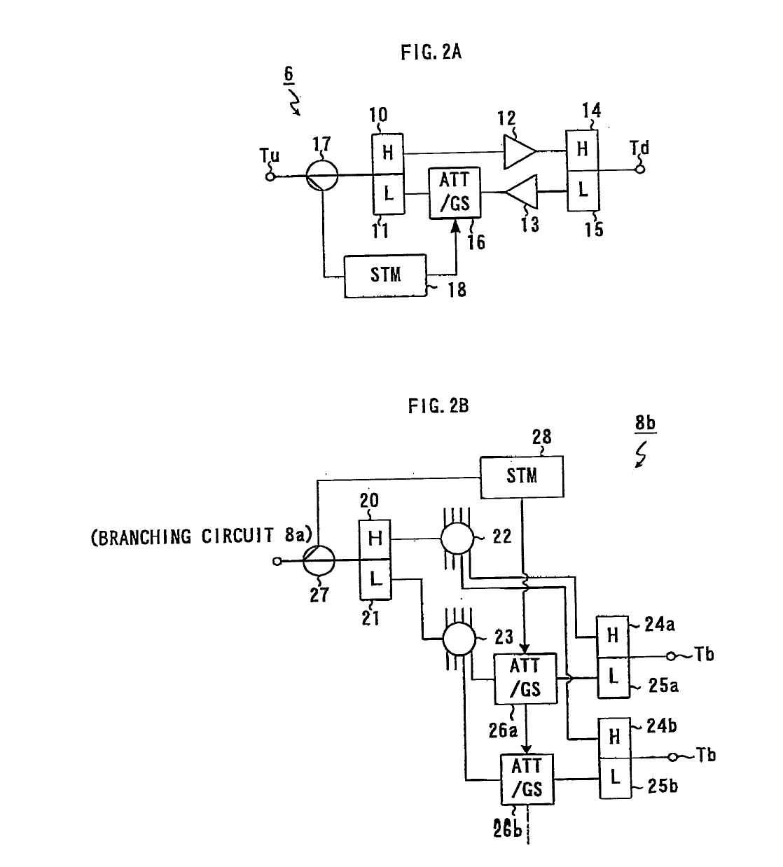

FIGS. 2A and 2B are block diagrams respectively showing a constitution of a main portion of the bi-directional amplifier 6 and the branching device 8.

As shown in FIG. 2A, the bi-directional amplifier 6 is provided with a downward path and an upward path. In the downward path, downward signal inputted from an upstream terminal Tu located on the center equipment 2 side is taken in via a high pass filter (HPF) 10, and after amplified to a predetermined level at an amplifying circuit 12, it is outputted to the terminal side from a downstream terminal Td via a HPF 14. In the upward path, upward signal inputted from the downstream terminal Td located on the terminal side is taken in via a low pass filter (LPF) 15, and after amplified to a predetermined level in an amplifying circuit 13, it is outputted to the center equipment 2 side from the upstream terminal Tu via a LPF 11.

The bi-directional amplifier 6 is also provided with a gate switch 16 and a status monitor 18. The gate switch 16 is a signal attenuation means having a function as a variable attenuator and located between the amplifying circuit 13 and the LPF 11 in the upward path. The status monitor 18 establishes bi-directional communication with the center equipment 2 via a branching circuit 17 located between the upstream terminal Tu, the HPF 10 and the LPF 11 to notify the center equipment 2 of the state of each part of the bi-directional amplifier 6, and receives control signal from the center equipment 2 and, according to the control signal, generates switch signal for the gate switch 16 as a signal extraction means.

In order to simplify the drawing, components for branching/merging transmission signal, and components used when the status monitor 18 detects the state of each part are omitted in FIG. 2A. However, it should be noted that the merging of upward signal is conducted downstream of the gate switch 16.

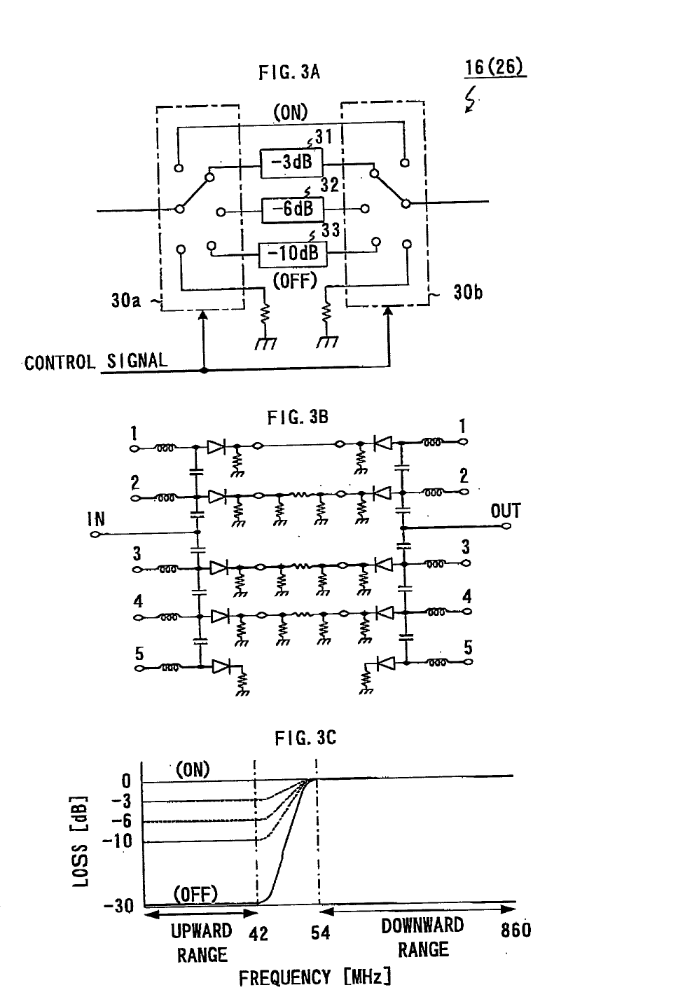

The gate switch 16, as shown in FIG. 3A, comprises selectors 30 (30a and 30b) which can be switched over for five paths according to the switch signal. Each of the paths is respectively shortened, opened, or connected to one of three attenuators 31, 32 and 33, each of which has different attenuation. In short, the gate switch 16 is adapted to pass (shorten: ON), block (open: OFF) or attenuate (in the present embodiment, in three levels of −3 dB/−6 dB/−10 dB) upward signal.

FIG. 3A is a diagrammatic view of the gate switch 16. The gate switch 16 can be practically constituted from diodes, resistance, inductors and capacitors, as shown in FIG. 3B, for example. In other words, by supplying power to one of terminals 1-4 to cause diodes to be conducted according to the control signal, attenuation set for the attenuator constituted from resistance between the conducted diodes is obtained. In this case, when power is supplied to the terminal 1, the gate switch 16 is in the on state, and when power is supplied to the terminal 5, the gate switch 16 is in the off state.

FIG. 3C shows frequency characteristics of the bi-directional amplifier 6.

The branching device 8, as shown in FIG. 1, comprises a branching circuit 8a and a gate part 8b which possesses one or more branching terminals Tb extending to the terminals for connecting the subscriber side terminals. The branching circuit 8a branches a part of the transmission signal from the transmission lines 4. The gate part 8b distributes the downward signal branched at the branching circuit 8a to each of the branching terminals Tb and also merges the upward signal inputted from each of the branching terminals Tb to be supplied to the branching circuit 8a.

The gate part 8b of the branching device, as shown in FIG. 2B, comprises a downward portion and an upward portion. The downward portion takes in the downward signal branched from the transmission lines 4 at the branching circuit 8a via a HPF 20, and after distributing the downward signal at a distributing circuit 22, outputs each of the distributed downward signal from each of the branching terminals Tb to the terminal side via HPFs 24 (24a, 24b, . . . ), respectively. The upward portion takes in the upward signal inputted from each of the branching terminals Tb of the terminal side, and after merging the upward signal into one at a merging circuit 23, outputs the merged upward signal to the branching circuit 8a side via a LPF 21.

The gate part 8b further comprises gate switches 26 (26a, 26b, . . . ) and a status monitor 28. The gate switches 26 are signal attenuation means having a function as a variable attenuator, and provided between the LPFs 25 and the merging circuit 23 in each upward path which constitutes the upward portion. The status monitor 28 establishes bi-directional communication with the center equipment 2 via a branching circuit 27 provided between the branching circuit 8a, HPF 20 and LPF 21 to notify the center equipment 2 of the state of each part of the branching device 8, and also receives control signal from the center equipment 2 and according to the control signal to generate switch signal for each of the gate switches 26. The gate switches 26 have the same constitution as the gate switch 16 constituting the aforementioned bi-directional amplifier 6 has, and therefore the description is not repeated.

A specific address is assigned to each of the bi-directional amplifiers 6 and the branching devices 8 in advance. When a destination address of transmission data sent from the center equipment 2 using a specified transmission frequency band (88 MHz-108 MHz) denotes the address of its own, each of the status monitors 18, 28 takes in the transmission data and executes instructions contained in the command.

Identification information for identifying each of the gate switches 26 can be added to the transmission data from the center equipment 2 to the branching devices 8. The status monitor 28 of the branching devices 8 (and the center equipment 2) is adapted to control each of the gate switches 26 individually.

In other words, the bi-directional amplifiers 6 amplify the downward signal flowing through the transmission lines 4, and at the same time, amplify and either pass, block, or attenuate (in three levels) upward signal flowing through the transmission lines 4.

Also, the branching devices 8 distribute the downward signal branched from the transmission lines 4 to be supplied to each of the branching terminals Tb. They either pass, block or attenuate the upward signal inputted from each of the branching terminals Tb per each of the branching terminals Tb and then merge the upward signal to be supplied to the transmission lines 4.

The center equipment 2, as shown in FIG. 1, is provided with a head end (HE) 40. The head end 40 comprises a receiving antenna for receiving TV broadcast signal transmitted from satellites and ground stations, video equipment for replaying TV signal recorded on video tapes and video disks, broadcast facilities for generating numbers of TV signal for broadcasting within the system with a self-broadcasting TV camera and the like and transforming the TV signal into the downward signal having a transmission frequency corresponding to a predetermined channel to be transmitted to each (also referred to as “node”) of the transmission lines 4.

The center equipment 2 is further provided with a measuring instrument (e.g. spectrum analyzer) 44, a node switcher 42, a monitor control device 50 and a downward control signal transmission part 46. The measuring instrument 44 analyzes frequency components with respect to the frequency band (ranging from 5 MHz-42 MHz) of the upward signal. The node switcher 42 selects one of the nodes N1-Nn connected to the transmission lines 4 according to selection signal and supplies the upward signal coming from the transmission lines 4 via the selected node Ni (i=1, 2, 3, . . . , n) to the measuring instrument 44. The monitor control device 50 generates control signal, which comprises an address assigned in advance to each of the line equipment 6, 8 and a command containing instructions, if required, to transmit the instructions for controlling the operation state to the line equipment such as the bi-directional amplifiers 6 and branching devices 8 provided on the transmission lines 4. It also takes out state notification signal transmitted from each of the line equipment 6, 8 to notify the operation state from the upward signal having a transmission frequency band corresponding to a predetermined control channel. The downward control signal transmission part 46 transforms the control signal generated by the monitor control device 50 into downward signal having the transmission frequency band corresponding to the predetermined control channel and transmits the downward signal to each of the transmission lines 4 via the head end 40.

The monitor control device 50 comprises a database 52, a signal measuring part 54, a signal level adjustment part 56 and a noise level adjustment part 58. The database 52 stores path data indicating connections of the transmission lines 4, arrangement of the line equipment 6, 8, etc. and search history data containing the state of the gate switches 16, 26, etc. The signal measuring part 54 serves as a signal level detection means as well as noise level detection means which measure signal level and noise level (or S/N ratio and C/N ratio) of upward signal on any of the transmission line 4 using the node switcher 42 and the measuring instrument 44. The signal level adjustment part 56 is a level adjustment means for generating control signal (i.e. level adjustment signal) which adjusts an output level of a cable modem connected to a terminal as the subscriber side terminal device so that the signal level of the upward signal measured at the signal measurement part 54 falls within a predined allowable range. The noise level adjustment part 58 generates control signal (i.e. attenuation adjustment signal) which adjusts attenuation of the upward signal transmitted from the line equipment so that the noise level measured at the signal measurement part 54 turns equal to or under a predetermined maximum noise level.

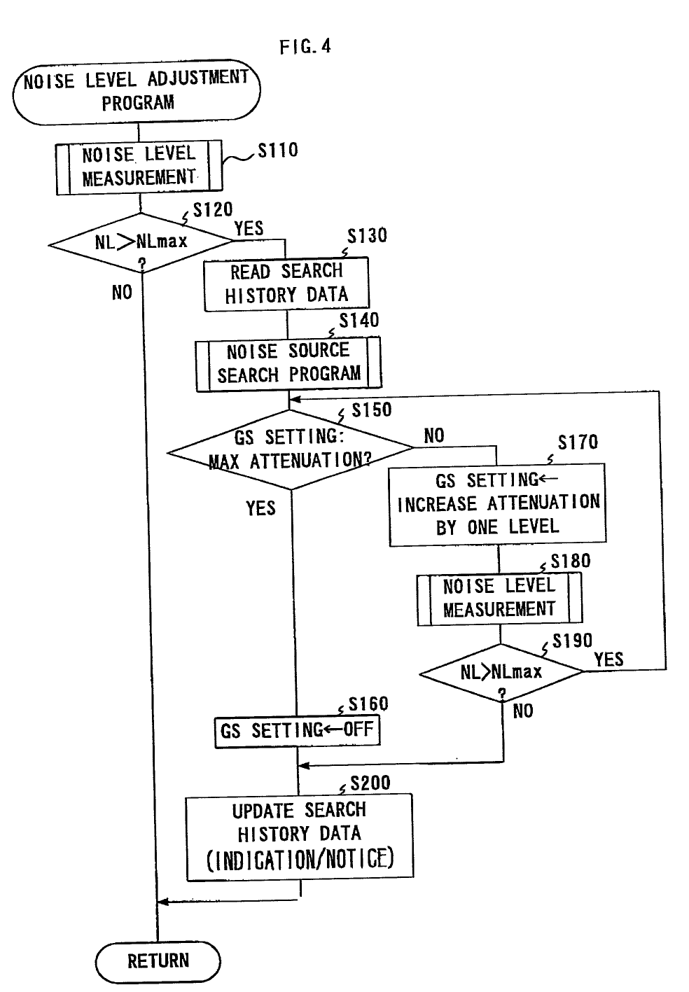

Here, a program executed by the noise level adjustment part 58 is explained by way of a flowchart shown in FIG. 4. This program is individually and repeatedly executed at each used node N1-Nn which is connected to the transmission lines 4.

As shown in FIG. 4, when this program is started, a noise level of upward signal is measured by the signal measurement part 54 (S110), and it is determined whether the noise level obtained from the measurement is larger than a predetermined maximum noise level NLmax (S120). If it is determined that the noise level is equal to or under the maximum noise level (NL≦NLmax), the program is ended without proceeding any further. On the contrary, if the measured noise level of the upward signal is larger than the maximum noise level (NL>NLmax), it is determined that a noise source should be searched. Then, search history data relating to a target node Ni is read from the database 52 (S130), and the noise source search program which specifies line equipment 6, 8 located the closest upstream of the noise source is executed (S140).

It is determined whether the gate switches 16, 26 of the line equipment (hereinafter, referred to as “specified line equipment”) specified by the noise source search program are set at the maximum attenuation (−10 dB in the present embodiment) (S150). If they are set at the maximum attenuation, since the attenuation cannot be increased any more, attenuation adjustment signal which is control signal for instructing the specified line equipment to set the gate switches 16, 26 to be in the off state is outputted (S160).

On the other hand, if the gate switches 16, 26 of the specified line equipment are not set at the maximum attenuation, attenuation adjustment signal for instructing the specified line equipment to increase the attenuation of the gate switches 16, 26 by one level is outputted (S170). Then, after waiting for the target line equipment 6, 8 which received this attenuation adjustment signal to set the gate switches 16, 26 as instructed, the signal measurement part 54 measures the noise level (S180).

It is then determined whether the measured noise level NL is larger than the maximum noise level NLmax (S190). If it is larger than the maximum noise level (NL>NLmax), it is determined that the noise level is not lowered enough and the program goes back to S150 to perform S150-S190 once again.

On the other hand, if the noise level measured at S180 is equal to or under the maximum noise level (NL≦NLmax), or if the gate switches 16, 26 of the specified line equipment are set at the off state at S160, identification information of the specified line equipment specified at S140, the state of the gate switches 16, 26 set at S160 or S170, and so on are added to the search history data read at S130 to be updated and stored in the database 52. Also, an indication or notice showing the database update (S200) is given, and the program is ended.

In short, performance of the noise level adjustment specifies the line equipment 6, 8 located the closest upstream of the noise source, and at this specified line equipment 6, 8, attenuation of the upward signal transmitted by the center equipment 2 is increased till the noise level drops equal to or under the maximum noise level.

When the attenuation of the upward signal at the above specified line equipment 6, 8 is increased, signal level of the upward signal outputted from a cable modem located downstream of the specified line equipment is substantially lowered along with the noise level. In this case, however, the signal level adjustment part 56 executes a program as the level adjustment means which transmits instructions to increase an output level of the upward signal to the cable modem so that the signal level of the upward signal received at the center equipment 2 falls within an allowable range. As a result, only the signal level of the upward signal supplied to the center equipment 2 via the above specified line equipment 6, 8 is increased, and transmission quality (i.e. S/N ratio and C/N ratio) is improved compared to that prior to the increase of attenuation of the upward signal at the above specified line equipment 6, 8.

When the indication or notice is given at S200, on-site operations for removing the cause of the noise existing downstream of the corresponding line equipment 6, 8 are performed based on the updated data. After the removal of cause of the noise, the gate switches 16, 26 of the above line equipment 6, 8 are switched to be in the on state.

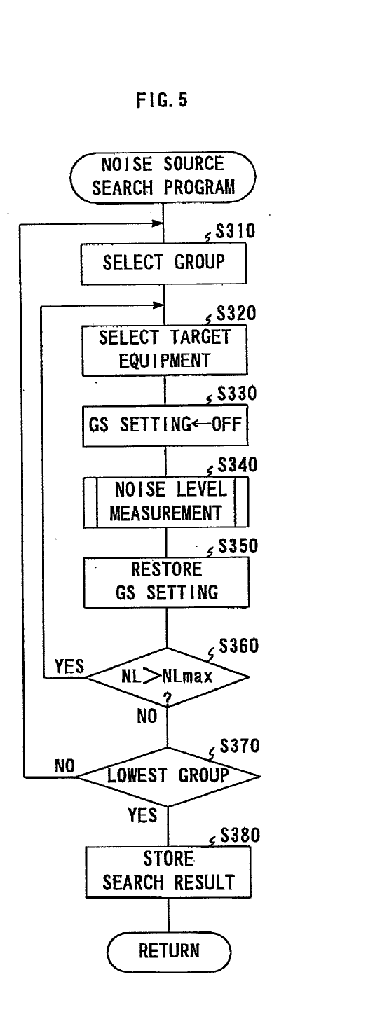

Now, details of the noise source search program executed at S140 are explained by way of a flowchart shown in FIG. 5.

As seen in FIG. 5, in the noise source search program, a target group is selected according to the search history data relating to the node Ni read at S130 (S310). It should be noted that in the present CATV system the line equipment 6, 8 are classified into groups per each transmission line, namely, the trunk 4a, branches 4b and sub-branches 4c. The line equipment 6, 8 located on the trunk 4a belong to the highest groups, and the other line equipment 6, 8 belong to the lower groups which are hierarchically defined per each transmission line branching from the line equipment 6, 8 belonging to the higher groups.

It should be also noted that after the program is started, the highest groups are selected at a first execution of S310 and the selection is shifted to the lower groups every time S310 is repeated. If plural groups exist at the same level, the selection is in order of the location. The group of which source line equipment 6, 8 are located the more downstream among the higher groups is firstly selected. If the source line equipment 6, 8 are the same, the selection is made in a predetermined order.

After the selection of a group, line equipment located the most downstream is selected as a target equipment among the line equipment 6, 8 belonging to that group (S320). At this time, the current state of the gate switches 16, 26 of the selected target equipment is extracted from the previously read search history data and stored.

Then, control signal (i.e. attenuation adjustment signal) for instructing the target equipment 6, 8 to set the gate switches 16, 26 to be in the off state is outputted (S330). In wait for the target equipment 6, 8 receiving this control signal to set the gate switches 16, 26 to be in the off state, measurement of the noise level is executed by the signal measurement part 54 (S340). Subsequently, control signal for instructing the target equipment 6, 8 to restore the original state of the gate switches 16, 26 stored at S320 is outputted (S350).

It is then determined whether the noise level NL measured at the S340 is larger than the maximum noise level NLmax (S360). If it is larger than the maximum noise level (NL>NLmax), it is determined that the noise source does not exist downstream of the target line equipment 6, 8, and the program returns to S320 to select new target equipment 6, 8 and repeat S320-S360.

On the other hand, if the noise level measured at S340 is changed to be equal to or under the maximum noise level (NL≦NLmax), it is determined that the noise source exists downstream of the target equipment 6, 8, and then it is determined whether the lower groups exist deriving from the target equipment 6, 8 (S370). If the lower groups exist, the program returns to S310 to select a new target group and repeat S310-S370. If the lower groups do not exist, the target equipment 6, 8 are specified as the line equipment 6, 8 located the closest upstream of the noise source. Then, the search result is stored (S380) and the program is ended.

In other words, in the noise source search program, the line equipment 6 on the trunk 4a is firstly selected as a target equipment. When the noise level is improved by setting the gate switches 16, 26 of the target equipment to be in the off state, the further search of the noise source is only conducted to each of the branches 4b branching from the target equipment. Therefore, the line equipment 6, 8 located the closest upstream of the noise source can be efficiently specified.

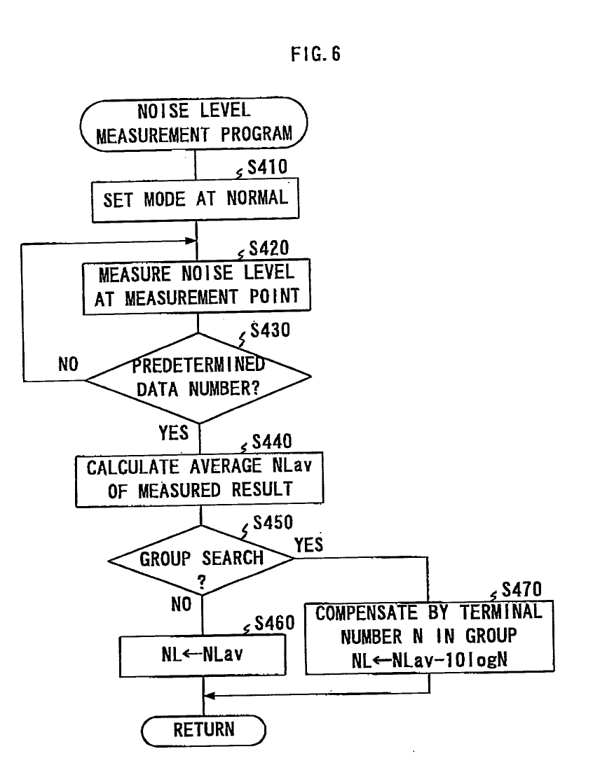

Now, the noise level measurement program started at S110, S180 and S340 and executed by the signal measurement part 54 is explained by way of a flowchart shown in FIG. 6.

As shown in FIG. 6, when this program is started, the measuring instrument 44 is set at a normal mode at which frequency components of a target signal at a certain time position is measured (S410). At this normal mode, the frequency components with respect to a frequency band (5 MHz-42 MHz) of upward signal are analyzed by the measuring instrument 44, and from the analyzed result, a noise level at the measuring point (i.e. measured frequency) is set at a later-explained maximum noise update program and stored as a measured value (S420).

It is then determined whether this measurement of the noise level is repeated a predetermined number of times C (e.g. ten times) (S430). If it is not repeated the predetermined number of times C, the program is returned to S420 to repeat the measurement of the noise level. On the other hand, if it is repeated the predetermined number of times C, an average NLav of the measured values is calculated according to an equation (1) below (S440) and it is determined whether the measurement is made during the group search (S450).

$$NLav = \frac{{\sum }_{i = 1}^{c} NLi}{C} . \qquad EQUATION 1$$

If this program is started from S180 and S340 and also a plurality of subscriber terminals are connected downstream of the specified line equipment or the target equipment at that point, it is determined that the measurement is made during the group search. Here, the number of the subscriber terminals connected downstream of the line equipment is called N.

If the measurement is not made during the group search, the average NLav of the measured values calculated at S440 is set as a noise level NL (S460). If the measurement is made during the group search, the average NLav of the measured value is compensated by an equation (2) and the resulted value is set as a noise level NL (S470). Then this program is ended.

Equation 2.

NL=NLav−10×log N

In the equation 2, the unit used for NL and NLav is dB. The equation 2 converts the average NLav of the measured values into a noise level per terminal.

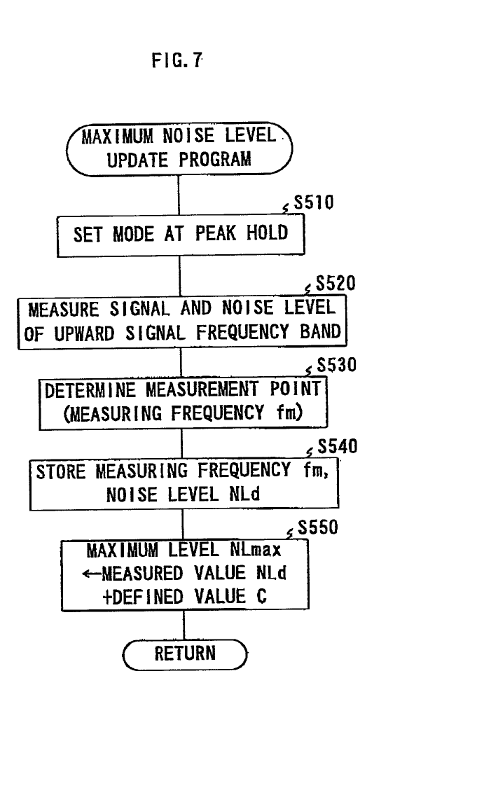

Now, the maximum noise level update program periodically executed by the signal measurement part 54 to update the maximum noise level NLmax referred to at S120, S190 and S360 is explained by way of a flowchart shown in FIG. 7.

As shown in FIG. 7, when this program is started, the measuring instrument 44 is set at a peak hold mode for holding a maximum level of the measurement result (S510). During a predetermined period, frequency components with respect to a frequency band (5 MHz-42 MHz) of upward signal is repeatedly analyzed by the measuring instrument 44 (S520). At this time, a maximum value per frequency component during the measurement is obtained as the measurement result by the measuring instrument 44.

Based on this measurement result, a plurality of measurement points are selected from ranges lower than a predetermined decision threshold (S530), and a frequency fm and a measured value NLd at the measurement points are stored (S540). The decision threshold should be set at a signal level which can be insured to be a vacant channel from which upward signal is not transmitted. The measurement points set at S530 are to be used at S420 of the noise level measurement program.

A defined value (e.g. 5 dB) is added to the stored measured value NLd as a margin and the resulted value is set as a maximum noise level NLmax (S550). Then the program is ended.

In the present embodiment, S130, S140 (S310-380) and S200 correspond to the search means of the present invention. S150-S190 correspond to the noise adjustment means.

As above described, in the CATV system of the present embodiment, when the noise level of the upward signal received by the center equipment 2 exceeds the maximum noise level, the transmission line 4 where the noise source exists is not cut off from the system but the attenuation of the upward signal at the line equipment 6, 8 located the closest upstream of the noise source is increased. Thus, the noise level of the upward signal received by the center equipment 2 is equal to or under the maximum noise level.

Therefore, according to the CATV system of the present embodiment, it is not only possible to prevent the whole system from being affected by abnormal noise, but also, since the upward signal from the cable modem located downstream of the noise source to the center equipment 2 is not interrupted when abnormal noise appears, services with respect to upward signal, such as a connection service to the Internet via the center equipment 2, etc., are available at all time and reliability of the system can be improved.

Furthermore, in the CATV system of the present embodiment, the search of the noise source is conducted hierarchically per group. Therefore, the line equipment 6, 8 located the closest upstream of the noise source are efficiently specified and the decrease in transmission quality due to the increase of confluence noise is quickly resolved.

Additionally, according to the CATV system of the present embodiment, when the branching devices 8 have a branching terminal Tb to which a lead-in wire to a subscriber house only authorized to use services with respect to downward signal is connected, it is possible to prevent unauthorized use of the services (e.g. Internet connection) with respect to upward signal at the above subscriber house by setting the gate switch 26 corresponding to the branching terminal Tb to be in the off state and realizing the feature as shown with a solid line in FIG. 3C.

[Second Embodiment]

The second embodiment is explained as follows.

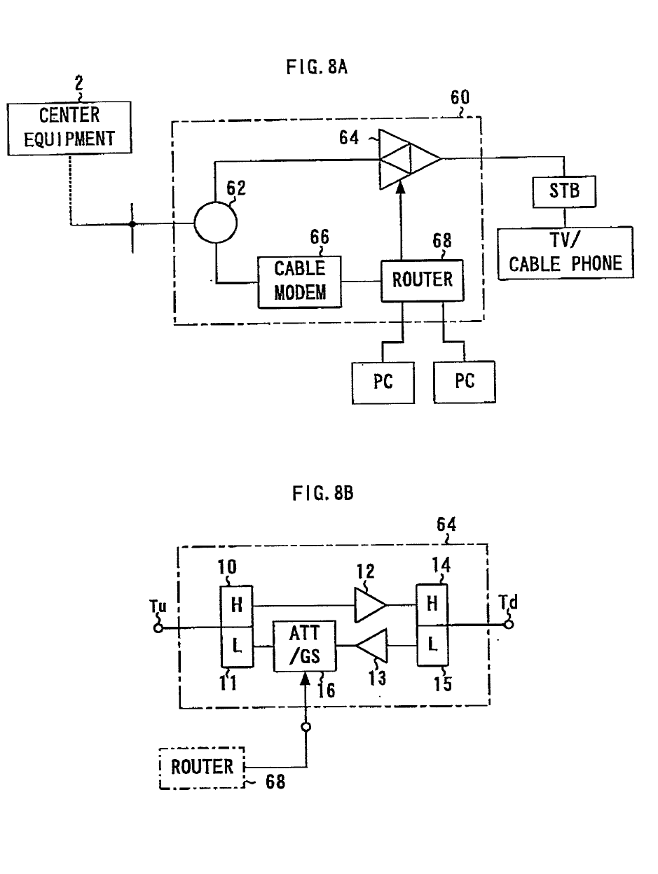

FIG. 8A is an explanatory view showing an internal structure of an information distribution board 60 provided at a subscriber house of the bi-directional CATV system.

As shown in FIG. 8A, the information distribution board 60 comprises a distributor 62 for distributing downward signal inputted via a protector into two destinations and also for mixing upward signal from the two destinations. To one of the transmission lines branching from the distributor 62, a booster 64 for bi-directionally amplifying the downward signal and upward signal flowing through the transmission line is connected, and to the other transmission line, a cable modem 66 and a router 68 are connected.

The booster 64, as shown in FIG. 8B, has the same constitution as the bi-directional amplifier 6 shown in FIG. 2A has except that the branching circuit 17 and the status monitor 18 are omitted. The gate switch 16 inserted to the upward path is adapted to be operated by external control signal. The same components as those of the bi-directional amplifier 6 are shown with the same symbols and the descriptions of the components are not repeated.

The output of the booster 64 is distributed to plural destinations (not shown) and then supplied to an information outlet provided at each room of the subscriber house. By connecting a TV receiver, a CATV phone and the like to the information outlet via a set top box, it is possible to watch and/or listen to broadcast programs and receive a CATV phone service.

A plurality of personal computers PCs are connected to the router 68 and communication between the PCs is available. Internet connection by way of the CATV system via the cable modem 66 is available for any personal computers PCs connected to the router 68.

The cable modem 66, like the status monitor 18 of the bi-directional amplifier 6, comprises a function to analyze the control signal from the center equipment 2. It can supply control signal (i.e. attenuation adjustment signal) to the booster 64 via the router 68.

In the bi-directional CATV system of the present embodiment where such an information distribution board 60 is provided at the subscriber house, it is possible to further improve the system reliability since the influence from the noise source is restricted within a small range by treating the booster 64 as line equipment equivalent to the bi-directional amplifiers 6 or branching devices 8.

Moreover, in this case, if the gate switch 16 of the booster 64 for switching over between passing and blocking of upward signal is controlled to be in the on state only when the subscriber watches and/or listens to audience participation shows or uses the CATV phone, confluence noise can be effectively reduced.

[Third Embodiment]

The third embodiment is explained as follows.

In the present embodiment, the gate part 8b of the branching device has little different constitution from that of the first embodiment. Therefore, only the difference is mainly discussed hereafter.

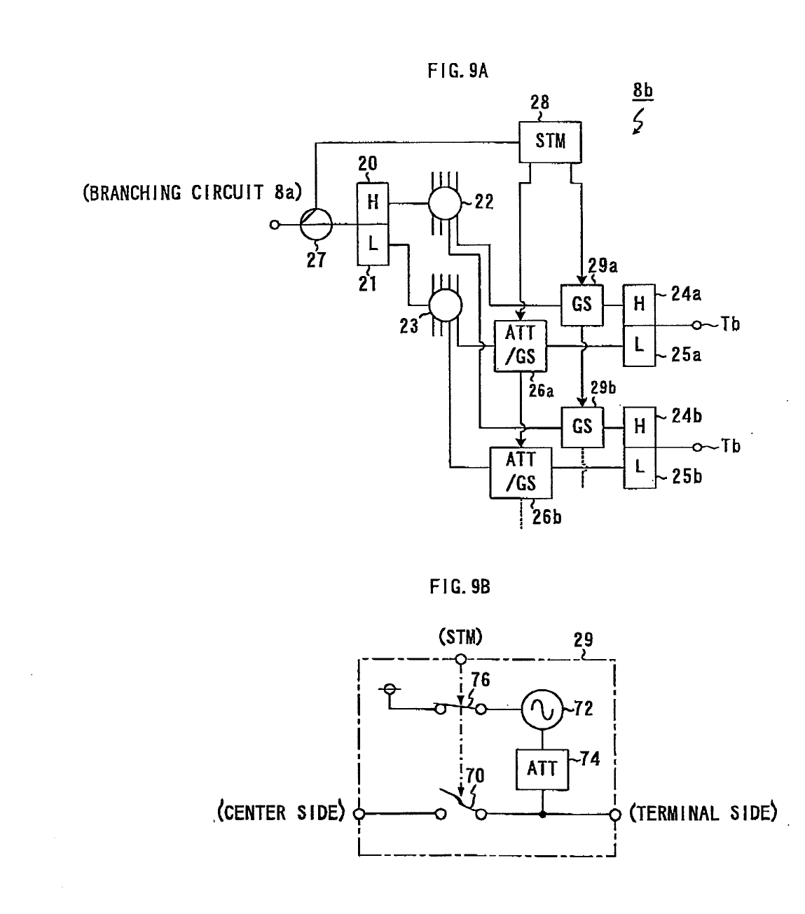

As shown in FIG. 9A, the gate part 8b of the branching device in the present embodiment comprises gate switches 29 (29a, 29b, . . . ) for switching over between passing and blocking of downward signal passing through the downward paths between the HPFs 24 (24a, 24b, . . . ) and the distributing circuit 22 located at the downward paths and constituting the downward portion, in addition to the components of the gate part 8b (see FIG. 2B) already described in the first embodiment.

In these additional gate switches 29, as shown in FIG. 9B, a noise generator 72 is connected, via an attenuator 74, downstream (i.e. branching terminal Tb) of a switch element 70 for changing over between passing and blocking of downward signal. Additionally, a power switch 76 which works with the switch element 70 is provided on the power supply line to the noise generator 72.

The status monitor 18 is adapted to receive control signal from the center equipment 2, and according to the control signal, generate switch signal for both of the gate switches 16 and 29.

When the gate switch 29 is in the on state and can pass the downward signal, that is, the switch element 70 is in the on state, the power switch 76 is in the off state and the noise generator 72 does not operate. On the contrary, when the gate switch 29 is in the off state and can block the downward signal, that is, the switch element 70 is in the off state, the power switch 76 is in the on state and white noise generated to be superimposed at the noise generator 72 is supplied to the branching terminals Tb. The strength of the white noise to be superimposed can be as much as that of the downward signal leaked downstream when the switch element 70 is in the off state.

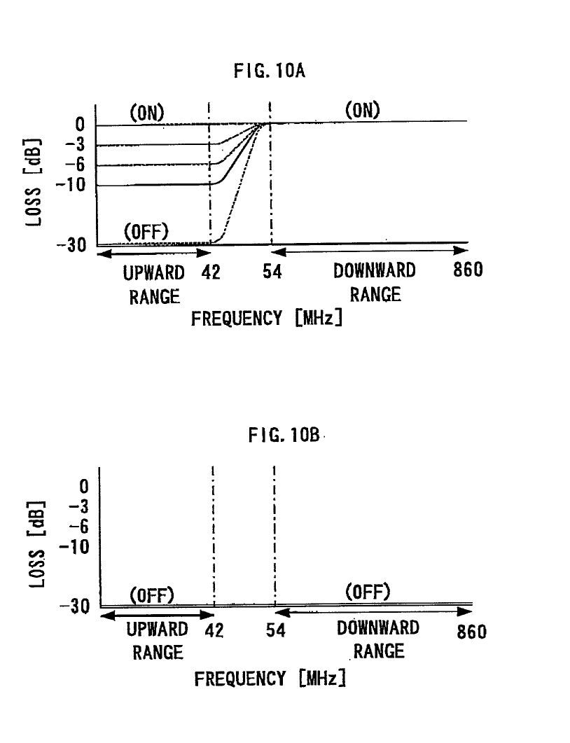

In the bi-directional CATV system constituted as such, if the gate switches 29 on the downward paths are in the on state, it is possible to realize the feature equivalent to that in the case of the first embodiment by operating the gate switches 26 on the upward paths as shown in FIG. 10A, and thus it is possible to obtain the same effect.

In the bi-directional CATV system of the present embodiment, in case that there are unused branching terminals Tb of the branching devices 8, it is also possible to prevent unauthorized use of CATV services via the branching terminals Tb by setting the gate switches 26, 29 to be in the off state on both of the corresponding upward/downward paths (see FIG. 10B).

Furthermore, such unused branching terminals Tb can be readily controlled remotely from the center equipment 2.

Moreover, in the present embodiment, if isolation of the switch element 70 is not large enough and there is a leak of the downward signal to the branching terminals Tb, since it is difficult to extract the downward signal due to the white noise generated at the gate switches 29, the aforementioned unauthorized use is more effectively prevented.

In other words, by generating the white noise to be superimposed downstream of the switch element 70 when the switch element 70 is in the off state, it is possible to adopt a switch element maintaining less isolation as the switch element 70 constituting the gate switches 29 for switching over between passing and blocking of downward signal. Thus, a device effective to prevent such an unauthorized use can be constituted at low cost.

In the present embodiment, the distributing circuit 22 corresponds to the distributing means, the gate switches 29 correspond to the switch means, and the noise generator 72, attenuator 74 and the power switch 76 correspond to the noise mixing means.

In the present embodiment, attenuation of the gate switches 16, 26 are set by five levels, that is, on state (≈0 dB), −3 dB, −6 dB, −10 dB and off state (≈−30 dB). However, the levels can be either less or more than five, and the values can be varied as long as they are set different at each level.

Although the attenuation is changed by levels in the present embodiment, it is possible to change the attenuation continuously by means of a variable attenuator. In this case, since there is no momentary interruption of signal in switching the attenuation, the switching becomes easy to control. Either electronic or mechanical manner can be adopted to change the attenuation.

Although the measured noise level to which a predetermined margin is added is set as the maximum noise level in the present embodiment, the noise level found by C/N (determined by a modulation/demodulation method and operation level used) necessary for stable data communication can be set as the maximum noise level. For example, in the case of QPSK (Quadrature Phase Shift Keying) method, since more than 18 dB of C/N is enough, a value decreased by 18 dB from the operation level can be set as the maximum level.

Although the search for target equipment is executed by selecting a group in the present embodiment, it is possible to conduct the search by directly selecting each equipment (terminal) individually one by one from the downstream according to the information in the database.

What is claimed is:

1. A bi-directional CATV system, in which a plurality of line equipment are connected to transmission lines from a center equipment to subscriber terminal devices, comprising means for specifying the line equipment located the closest upstream of a noise source when a noise level received by the center equipment exceeds a predetermined maximum noise level, and means for increasing attenuation of upward signal at the line equipment.

2. The bi-directional CATV system as set forth in claim 1 further comprising means for automatically adjusting a signal level of upward signal transmitted by the subscriber side terminal devices according to instructions from the center equipment so that the noise level of the upward signal received at the center equipment falls within a predetermined allowable range.

3. Line equipment connected to transmission lines of a bi-directional CATV system from a center equipment to subscriber side terminal devices, comprising
transmission line means for transmitting downward signal from the center equipment and
signal attenuation means for varying attenuation of upward signal to the center equipment according to attenuation adjustment signal superimposed on the downward signal transmitted from the transmission line means.

4. The line equipment as set forth in claim 3 further comprising
distribution means for distributing downward signal from the center equipment to plural destinations, and
switch means for controlling passing and blocking of downward signal at every distribution path through which the signal distributed at the distribution means is transmitted according to switch signal superimposed on the downward signal from the center equipment.

5. The line equipment as set forth in claim 4 further comprising noise mixing means for working with the switch means, and when the switch means is set to block passing of downward signal, for generating white noise to be superimposed downstream of the switch means.

6. A center equipment of a bi-directional CATV system in which a plurality of line equipment are connected to transmission lines to subscriber side terminal devices comprising:
noise level detection means for detecting a noise level in a frequency band used for transmission of upward signal;
search means for searching a noise source to specify the line equipment located the closest upstream of the noise source when the noise level detected by the noise level detection means exceeds a predetermined maximum noise level; and
noise adjustment means for generating attenuation adjustment signal to adjust attenuation of the upward signal at the line equipment specified by the search means so that the noise level detected by the detection means is equal to or under the maximum noise level and mixing the attenuation adjustment signal on downward signal to be transmitted.

7. The center equipment as set forth in claim 6 comprising
signal level detection means for detecting a signal level of the received upward signal, and
level adjustment means for generating level adjustment signal to adjust transmission level of the upward signal at the subscriber side terminal devices so that the signal level detected by the signal level detection means falls within a predetermined allowable range and mixing the level adjustment signal on downward signal to be transmitted.
